(19) United States
(12) Patent Application Publication
(10) Pub. No.: US 2013/0103667 A1
(43) Pub. Date: Apr. 25, 2013

(54) Sentiment and Influence Analysis of Twitter Tweets

(71) Applicant: Metavana, Inc., San Francisco, CA (US)

(72) Inventor: Duong-Van Minh, San Diego, CA (US)

(73) Assignee: Metavana, Inc., San Francisco, CA (US)

(21) Appl. No.: 13/653,856

(22) Filed: Oct. 17, 2012

Related U.S. Application Data
(60) Provisional application No. 61/548,183, filed on Oct. 17, 2011.

(51) Int. Cl. G06F 17/30

(52) U.S. Cl. CPC G06F 17/30864; H04L 51/32
USPC 707/709; 709/206; 707/730

(57) ABSTRACT

The present invention is directed to a system, method, and article of manufacture that employs a sentiment engine for conducting sentiment and influence analysis of various types of messages from the social media hosts or websites to extract opinions on different categories, which includes services, products or hotels, and others, collectively referred to as “the keyword product”. The sentiment engine includes a sentiment module configured to gather opinions or determine sentiment expressed in documents, a crawling module configured to servers of social network websites to obtain at least a subset of the documents or opinions from social media websites, a keyword module configured to extract keywords from documents, a filtering module configured to filter keywords and documents, and a classification module configured to classify documents, sentences, and/or keywords, a polarity prediction module configured to predict the polarity of a sentiment sentence, and a social media net promoter score configured to calculate a loyalty metric of users from social media websites, and a message analysis module configured to conduct analysis of a message from host social media sites, forums, blogs and product/service providers. The message analysis module includes analyzing message from other host social media sites.

### CROSS REFERENCES TO RELATED PATENT APPLICATIONS

This application claims priority to U.S. Provisional Application Ser. No 61/548,183 entitled “Sentiment and Influence Analysis of Twitter Tweets,” filed on 17 Oct. 2011, the disclosure of which is incorporated herein by reference in its entirety.

### FIELD OF THE INVENTION

The present invention relates to methodologies to extract and categorize opinion information from Twitter™ tweets™ and similar postings, including social media sites, and to score the influence or clout of the individual(s) associated with said postings.

### BACKGROUND

The World Wide Web (WWW), or simply the “Web”, is the well-known collection of interlinked hypertext documents hosted at a vast number of computer resources (“hosts”) communicatively coupled to one another over networks of computer networks known as the Internet. These documents, which may include text multimedia files and images. are typically viewed as Web pages with the aid of a Web browser—a software application running on a user's computer system. Collections of related Web pages that can be addressed relative to a common uniform resource locator (URL) are known as websites, and are typically hosted on one or more Web servers accessible via the Internet.

In recent years, websites featuring User Generated Content (UGC), that is content created and posted to websites by owners of and, sometimes, visitors to those sites, have become increasingly popular. UGC accounts for a wide variety of content, including news, gossip, audio-video productions, photography and social commentary, to name but a few. Of interest to the present inventors is UGC which expresses opinions (usually, but not necessarily, of the person posting the UGC), for example of products, services, or combinations thereof (herein, the term “product” refers to mean any or all such products and/or services). Social media sites in particular have become popular places for users of those sites to post UGC that includes opinion information.

The opinions and commentary posted to social media sites have become highly influential and many people now make purchasing decisions based on such content. Unfortunately, however, for people seeking out such content in order to inform prospective purchasing decisions and the like, the task is not always easy. Blogs, micro-blogs and social networking sites are replete with ever-changing content, and even if one can locate a review or similar post of interest, such reviews typically include much information which is of little or no relevance to the topic and/or the purpose for which the review is being read. Further, while the UGC and opinion information can be of great value to advertisers, retailers and others, it is extremely burdensome to collect and analyze in any systematic way, and even more difficult to extract therefrom meaningful commentary or opinions which can form the basis for appropriate responses or informed decisions.

### SUMMARY OF THE INVENTION

Embodiments of the present invention provide a system, method, and article of manufacture that employs a sentiment engine for conducting sentiment and influence analysis of various types of messages (such as tweets and blogs) from the social media hosts or websites, including Twitter™, Facebook™, and Linkedin™, extract opinions on different categories, which includes services, products or hotels, and others, collectively referred to as “the keyword product”. The sentiment engine includes a sentiment module configured to gather opinions or determine sentiment expressed in documents, a crawling module configured to servers of social network websites to obtain at least a subset of the documents or opinions from social media websites, a keyword module configured to extract keywords from documents, a filtering module configured to filter keywords and documents, a classification module configured to classify documents, sentences, and/or keywords, a polarity prediction module configured to predict the polarity of a sentiment sentence, a social media net promoter score (SNPS) configured to calculate a loyalty metric of users from social media websites, and a message analysis (also referred to as “tweets”) module 44 configured to conduct analysis of a message (or text, graphics, or video) from host social media sites, forums, blogs and product/service providers, such as tweets™ from Twitter online message service. The message analysis module 44 includes analyzing message from other host social media sites, such as Facebook and Linkedin, Yelp™, blogs, and Sina Weibo. An influential score module is configured to compute the amount of influence that an author of a tweet has in his or her message. The functionalities of these modules may be combined with one another or in addition to other modules.

Broadly stated, a computer-implemented method for sentiment and influential analysis comprises receiving, by a processor, a plurality electronic messages posted by one or more users on social media web websites; identifying, by a processor, a polarity of the sentiment-bearing keywords for each electronic message using a phase transition formula; determining, by a processor, at least one category corresponding to the at least one sentiment-bearing keyword associated with each electronic message; and determining, by a processor, an influence attribute fix each electronic message based on a plurality of influence factors.

The structures and methods of the present invention are disclosed in the detailed description below. This summary does not purport to define the invention. The invention is defined by the claims. These and other embodiments, features, aspects, and advantages of the invention will become better understood with regard to the following description, appended claims and accompanying drawings.

### BRIEF DESCRIPTION OF THE DRAWINGS

The invention will be described with respect to specific embodiments thereof, and reference will be made to the drawings, in which:

FIG. 1 is a system diagram illustrating a classification and sentiment determination server in a communication network in accordance with the present invention.

FIG. 2 is a software system diagram illustrating the various modules of a sentiment engine in the classification and sentiment determination server in accordance with the present invention.

FIG. 3 is a flow diagram illustrating the process of extracting, categorizing, and identifying keywords in accordance with the present invention.

FIG. 4 is a flow diagram illustrating a method for filtering documents from the corpus of files according to some embodiments of the present invention.

FIG. 5 is a flowchart illustrating the highlights of a method for determining sentiment expressed in a sentence of a document in accordance with some embodiments of the present invention.

FIGS. 6A-6C are flow diagrams illustrating one embodiment of the sentiment determination and influence analysis process as applied to Twitter tweets in accordance with the present invention.

FIGS. 7A-7B show a sample screen shot of the user interface (UI) for a smart phone showing a graph with buzz feature in accordance with the present invention.

FIG. 8 shows a sample buzz plot in accordance with some embodiments of the present invention,

FIGS. 9A-9B show a sample screen shot of the UI with the sentiment feature in accordance with some embodiments of the present invention.

FIG. 10 is a block diagram of a machine in the example form of a computer system within which may be executed a set of instructions for causing the machine to perform any one or more of the methodologies discussed herein.

### DETAILED DESCRIPTION

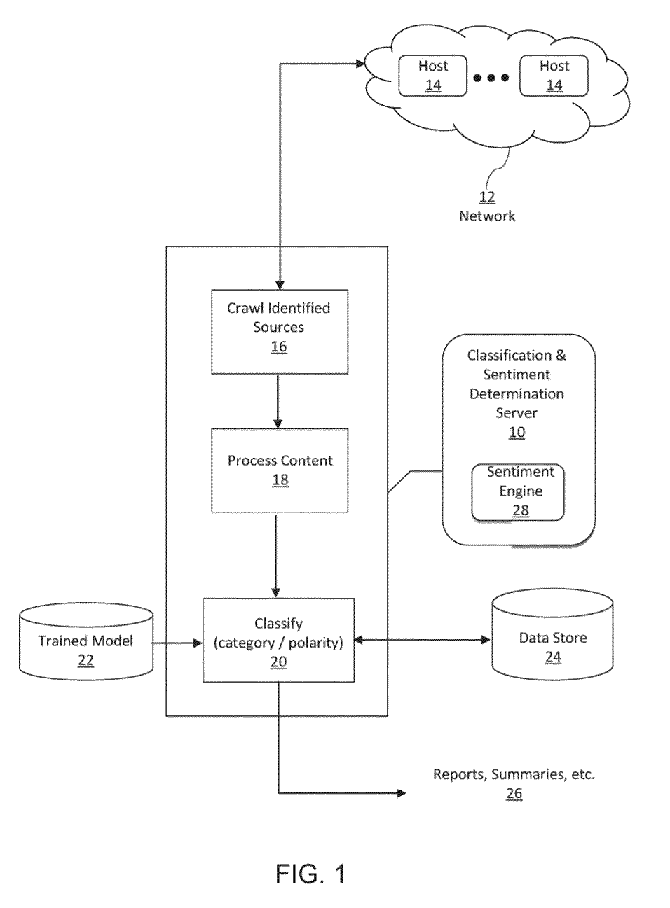

A description of structural embodiments and methods of the present invention is provided with reference to FIGS. 1-10. It is to be understood that there is no intention to limit the invention to the specifically disclosed embodiments but that the invention may be practiced using other features, elements, methods and embodiments. Like elements in various embodiments are commonly referred to with like reference numerals. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

Referring now to FIG. 1, a classification and sentiment determination server 10 is communicatively coupled to a network 12 (e.g., the Internet or a wireless network), which includes hosts 14 at which UGC of interest is located. The hosts may host social media sites (e.g., social networking sites), forums, blogs, product/service provider sites, etc., and the UGC of interest may include opinion-bearing content. In one particular embodiment of the invention, the UGC is Twitter tweets. The output of the classification and sentiment determination server is stored to a data store 24 (which may be included in or separate from the classification and sentiment determination server). The opinion-bearing content may be included within or with non-opinion-bearing content and non-UGC, hence the need to extract it before it can be analyzed/used.

In the illustration, the functions of classification and sentiment determination are shown as being performed by the same server; however, this need not necessarily be so. In other arrangements, the classification and sentiment determination functions may be performed by different servers and/or may be distributed across multiple servers or other computer-based platforms. The precise hardware arrangement used to perform the methods of the present invention is not necessarily critical to the invention.

In order to extract the UGC from the various content sources, customized Web crawlers are developed. In some instances it may be possible to use general purpose Web crawlers to extract UGC from the content sources, but increasingly it is the case that individual websites employ specialized formatting or other features, which makes the use of per-site custom Web crawlers appropriate. This way, the Web crawlers can be designed to extract only desired content (e.g., content which may include opinion-bearing information) and not all content at a particular site. This can reduce the burden on the analysis components discussed below. The customized crawlers are deployed to gather the content (and, optionally, associated metadata) from the identified sites 16. Content so gathered is processed (e.g., using stop-word removal) 18, the most frequent n-grams are identified, and these n-grams are then used to identify categories as part of a classification and polarity determination process 20. The categories are identified with the aid of category information obtained from a trained model 22, which identifies for each category sentiment-bearing keywords.

After the categories have been determined, the sentiment-bearing words associated with those categories are identified and their orientations (polarities) determined. In one embodiment of the invention, adjectives associated with each category keyword in the extracted content are identified as the opinion-bearing keywords. Keywords can be extracted automatically (e.g., for the entire training dataset or a portion thereof and using a lexicon provided to an extraction engine) and those adjectives can be manually tagged with a polarity (e.g., positive, negative, or neutral). Synonyms and antonyms of identified adjectives may be included in the sentiment-bearing words list with their polarity for the selected category.

The identified categories and associated opinion-bearing keywords from trained model 22 are used by the classification and sentiment determination server 10. As indicated above, this model is preferably constructed on a per-category basis so that category-appropriate polarities can be identified 20 and associated with the respective n-gram keywords.

The trained model 22 preferably associates category keywords and their respective opinion-bearing keywords, segregated or otherwise tagged by polarity. Categories may exist at a variety of granularities, for example hotels, rooms, bathrooms, etc. Within each category, adjectives or other identified opinion-bearing keywords may be segregated as positive, negative, or neutral. In some instances, the model will be stored locally by the classification and sentiment determination server 10, but in other cases it will be stored remotely therefrom. In instances where multiple classification and sentiment determination servers are deployed, a single instance of the trained model may be made available to each of the servers, so that the servers all classify and determine sentiment of UGC in the same way, according to a common rule set. In other cases, different classification and sentiment determination servers may be given individual responsibilities for certain sources of UGC and each may have its own unique model, customized to that data source.

Regardless of such implementation specifics, the model 22 is used by the classification and sentiment determination server 10 to classify 20 content harvested by the Web crawlers by category and sentiment. To do so, the classification and determination server 10 processes 18 the harvested content to extract the category and sentiment keywords and then consults the trained model 22 to determine the polarity of the sentiment-bearing keywords. The output of the classification and sentiment determination server 10 is then stored to data store 24 and may later be used by the sentiment server 10 to create summaries 26 regarding the different products, and/or their features, for which UGC content was harvested.

The summaries 26 may be provided to advertisers, merchants or others and used to create/revise advertising and marketing campaigns or other for other purposes. Alternatively, or in addition, the summaries may be posted to other websites for easy review by users interested in the subject products. In still further embodiments, the summaries may be provided to search engine operators for return to users that execute searches related to the subject products. Of course, such search engines may be owned/operated by the same entity that owns/operates the sentiment server 10 and the sentiment server 10 may respond to queries executed by users of the search engine by providing pre-computed and/or computed-on-the-fly summaries concerning products which are identified in search queries.

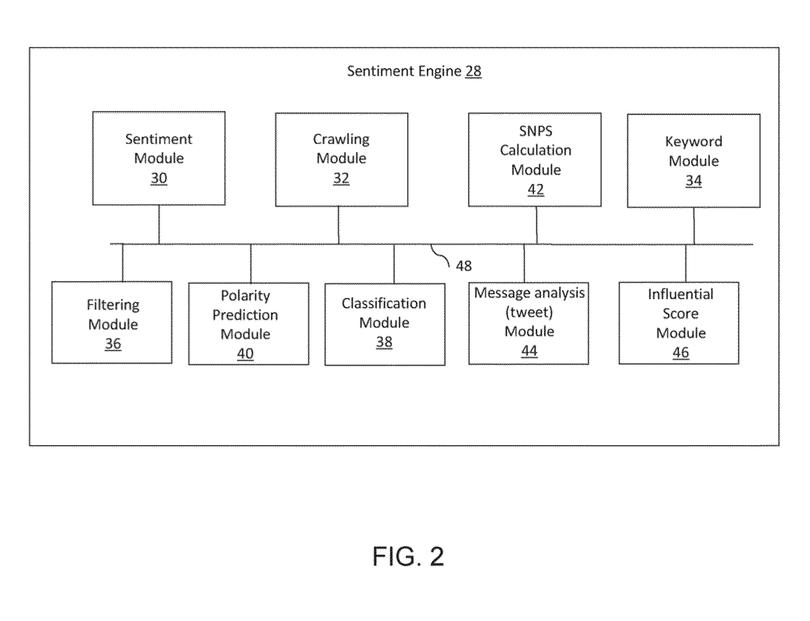

The classification and sentiment determination server 10 includes a sentiment engine 28, which is illustrated in FIG. 2. The sentiment engine 28 includes a sentiment module 30 configured to gather opinions or determine sentiment expressed in documents, a crawling module 32 configured to crawl servers (not shown) to obtain at least a subset of the documents or opinions from social media websites 14, a keyword module 34 configured to extract keywords from documents, a filtering module 36 configured to filter keywords and documents, a classification module 38 configured to classify documents, sentences, and/or keywords, a polarity prediction module 40 configured to predict the polarity of a sentiment sentence, a social media net promoter score 42 configured to calculate a loyalty metric of users from social media websites, and a message analysis (also referred to as “tweets”) module 44 configured to conduct analysis of a message (or text, graphics, or video) from host social media sites, forums, blogs and product/service providers, such as tweets from Twitter online message service. The message analysis module 44 includes analyzing message from other host social media sites, such as Facebook and Linkedin, Yelp, blogs, and Sina Weibo ( [symbol] ). An influential score module 46 is configured to compute the amount of influence that an author of a tweet™ in his or her message. The functionalities of these modules may be combined with one another or in addition to other modules. For example, the sentiment module 30 may include the functionality of the keyword module 34 and the filtering module 36. The sentiment module 30, the crawling module 32, the keyword module 34, the filtering module 36, and the classification module 38 are coupled to a communication bus 48.

For additional information on determining sentiment expressed in documents, see U.S. patent application Ser. No. 12/977,513 entitled “System and Method for Determining Sentiment Expressed in Documents”, filed on Dec. 23, 2012, and U.S. patent application Ser. No. 13/632,011 entitled “Sentiment Analysis from Social Media Content,” filed on Sep. 30, 2012, all owned by the assignee of this application and incorporated by reference in their entirety as if fully set forth herein.

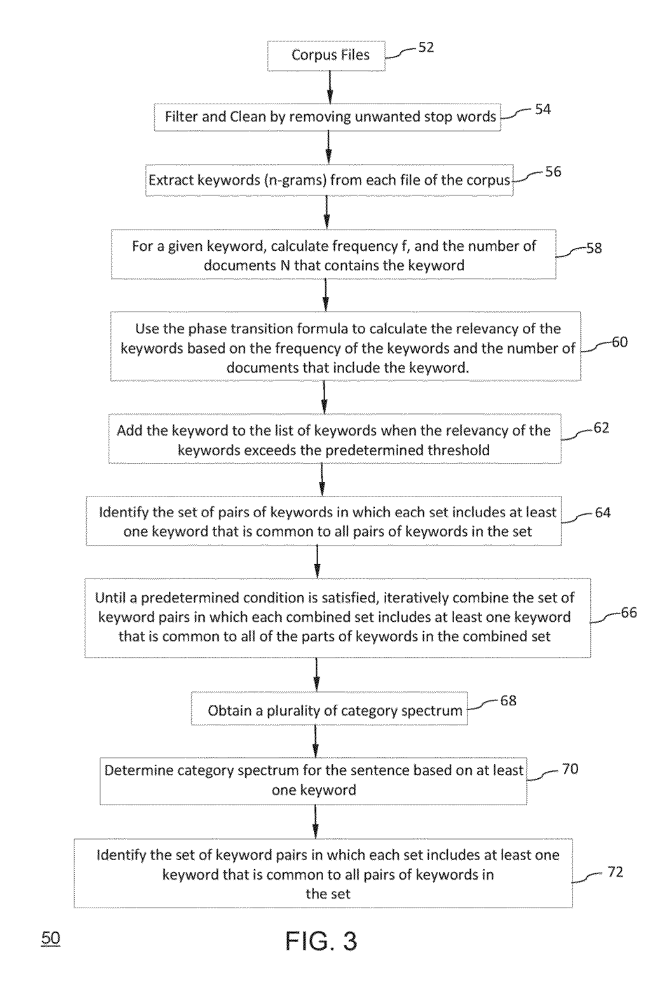

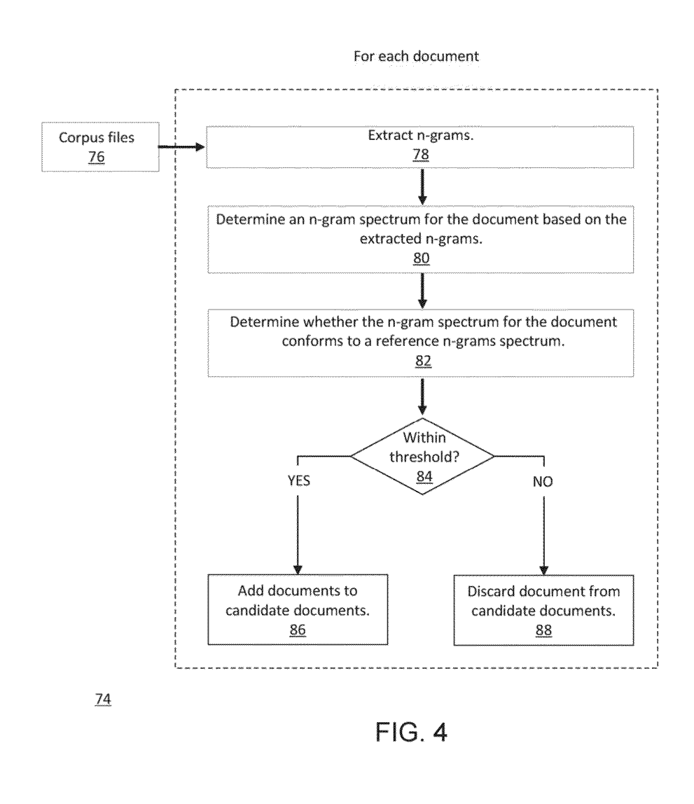

Turning now to FIG. 3, the sentiment engine 28 is configured for the keyword extraction process used to identify categories and opinion-hearing keywords 50 begins with the corpus of files or other content 52 downloaded by the crawlers and stored in the content store 54. The sentiment engine 28 retrieves corpus files at step 52, and filters and cleans the files by removing unwanted stop words 54. These files are cleaned, for example by stop-word filtering, to remove any words, phrases or other constructs that are known not to be opinion-bearing content 54. The data files extracted through the process in FIG. 3 are preprocessed for keyword extraction. This process is used to identify categories and opinion bearing keywords, which are then used to train the sentiment engine 28. The process of keyword extraction is described with reference to FIG. 4.

FIG. 4 illustrates a method 74 for filtering documents from the corpus of files according to some embodiments of the present invention. For each candidate document in the corpus 76, n-grams are extracted (78), an n-gram spectrum for the document is determined based on the extracted n-grams (80), wherein the n-gram spectrum indicates a frequency of occurrence of n-grams as a function of a size of n-grams, and a determination is made as to whether the n-gram spectrum for the document conforms to a reference n-gram spectrum (82) within a predetermined threshold (84), wherein the reference n-gram spectrum is defined by a predetermined function. In some embodiments, the predetermined function is cx^{-a}·e^{-bx}, wherein x is the size of the n-gram, and wherein a, b, and c are predetermined values that place a peak of the predetermined function between an n-gram of size 2 and an n-gram of size 3. In some embodiments, the value of b is between 1 and 2, and the value of c is between 1 and 2, The candidate document is retained (86) when the n-gram spectrum for the document conforms to the reference n-gram spectrum within the predetermined threshold, and discarded (88) when the n-gram spectrum for the document does not conform to the reference n-gram spectrum within the predetermined threshold.

Returning to FIG. 3, keywords are then extracted from the retained documents 56. At step 56, the keyword extraction module 34 is configured to extract keywords from each document file of the plurality of documents. Keywords may be regarded as those n-grams extracted during the filtering process. At step 58, for each extracted keyword, the keyword module 34 is configured to calculate a frequency, f, of the keyword in the plurality of the documents, and a number of documents, N, that include the keyword, are calculated 58. At step 60, the keyword module 34 is configured to use a phase transition formula to calculate the relevancy of the keyword, based on its frequency in the plurality of documents and the number of documents that include the keyword. In one embodiment, the phase transition formula used to determine the relevancy of an individual keyword is f/N^{x}, where x≧1. At step 62, the relevancy is compared to a pre-established threshold and the keyword module adds the keyword to the list of keywords When the relevancy of the keyword exceeds that threshold. Otherwise, the subject keyword is not added to the list.

Having produced the list of relevant keywords (i.e., those with a relevancy score above the predetermined threshold), the classification module now determines unique pairs of keywords that are related to each other. For example, assume that the corpus of files or other content included m files, from which were extracted n keywords. Each n^{th} keyword from an m^{th} file is matched against (m−1) files, thus forming different clusters. Keywords belonging to each cluster are believed to belong to the same domain. Clusters obtained through this process are later refined and named as categories. The classification module 38 identifies sets of pairs of the keywords in which each set includes at least one keyword that is common to all of the pairs of keywords in the set 64. Next, the classification module 38 iteratively combines the sets of the pairs of keywords in which each combined set includes at least one keyword that is common to all of the pairs of keywords in the combined set until a predetermined termination condition is achieved 66.

Thus, the classification module determines sets of keywords that are related to each other and iteratively combines the sets to form categories. For example, the classification module may identify the following pairs of keywords from the list of keywords:
{Paris, Romance},
{Paris, City of Love},
{Paris, French },
{Dog, Beagle },
{Cat, Siamese}.
   The classification module may then determine that {Paris, Romance, City of Love, French} is a set of related keywords (e.g., a category) because the word “Paris” is common to the pairs {Paris, Romance}, {Paris, City of Love}, {Paris, French }. Note that the classification module may also determine that {Paris, Romance, City of Love} is a set of related keywords. The level of specificity desired for a category determines the predetermined termination condition. The more keywords that are used to describe the category, the more specific the category is (e.g., {Paris, Romance, City of Love, French} is more specific than {Paris, Romance, City of Love}).

At step 68, The classification module 38 then obtains a plurality of (dot products) category spectrums. At step 70, the classification module 38 then determines at least one dot product that exceeds a predetermined threshold. A category spectrum may be represented by the pair {WordID, Frequency}, where the value of WordID corresponds to a unique keyword and Frequency corresponds to a frequency of occurrence of the associated keyword. For example, the keyword “Paris” may have a WordID of 8 and a frequency of occurrence of 1002. Thus, the category spectrum includes a pair {8, 1002}. These category spectrums may be visually represented. For example, on a 2-dimensional plot, one axis (e.g., the x-axis) may be WordID and the other (orthogonal) (e.g., the y-axis) may be Frequency. At step 72, in some instances, the category spectrums may be normalized so that the area under each of the category spectrums is the same. In other words, the sentiment engine 28 is configured to identify the set of keyword pairs in which each set includes at least one keyword that is common to all pairs of keywords in the set. Doing so may reduce comparative bias between categories. Normalizing may be accomplished by normalizing the frequency of occurrence of the filtered keywords to produce the normalized category spectrum for the category.

The sentiment engine 28 is responsible for determining polarities of individual sentences in a review or other item of UGC. Therefore, in order to employ the sentiment engine, the harvested UGC content is split into sentences, which sentences may be units that are smaller or larger than the grammatical unit typically termed a sentence. That is, the sentences applied to the sentiment engine may be grammatical sentences, portions of one or more grammatical sentences, or multiple grammatical sentences. For convenience, The term sentence refers to all such constructs which may form inputs for the sentiment engine.

As indicated above, the sentences are first processed to identify categories to which they refer or relate. Those sentences that include category keywords are passed to the sentiment engine. The sentiment engine first determines whether or not the subject sentence contains any opinion-bearing words. A positive and statistically significant correlation between adjectives and subjectivity of the opinion may be observed. Therefore, in one embodiment of the present invention, the presence of an adjective in a sentence is deemed to be a strong indication that the sentence is subjective, i.e., sentiment-bearing. Accordingly, the present sentiment engine deems adjectives as sentiment-bearing keywords and any sentence that is classified into a category is analyzed for such sentiment-bearing keywords. These sentences that are determined to contain at least one category keyword and one or more sentiment-bearing keywords are referred to as sentiment sentences.

For each sentiment sentence reviewed by the sentiment engine, all adjectives in the sentence are extracted as sentiment-bearing keywords (the adjectives in the sentence being located using an adjectives lexicon provided to the sentiment engine), and the most adjacent adjective to a subject category keyword is identified as the effective adjective for that category. For example, in the following sentiment sentence: “The beds were nice, the sofas and chairs were comfy, and the kitchenette was stocked with the essentials.”, the words nice, comfy and stocked may be identified as sentiment-bearing keywords and the word nice is identified as the effective adjective for the category bed. Effective adjectives are used to identify the orientation (polarity) of sentiment sentences by reference to the trained model. In this way, the category keywords and the sentiment-bearing words included in the harvested UGC are used to classify reviews and similar information concerning the subject product.

Various refinements for this overall method may be introduced. For example, in one embodiment of the invention for each sentence in the harvested UGC, category keywords may be identified (as described above) and sentiment-bearing words located. A sentence that is found to contain at least one category keyword and one or more sentiment-bearing words may be referred to as a sentiment candidate. For each category: adjective keyword pair in a given sentiment candidate, the sentiment engine may compute a distance (e.g., in terms of number of words) between them. If the distance is less than a predefined threshold, then the sentiment candidate is identified as a sentiment sentence for the category the subject keyword belongs to. Otherwise, the sentiment candidate is ignored.

To identify the polarity of the sentiment sentence for the identified category, we need to consider the following situations:

1. A sentiment sentence might contain both likes and dislikes concerning some or all of the categories of the product. In such instances, the opinion words may be either positive or negative. Each opinion word is, however, likely to be closer in distance to the category keyword that it is related to than to other category keywords. Therefore, such a sentence can be listed many times for each category with respective probabilities for each sentiment: category pair. For example, in the sentence “The staff was nice, however, the room was very small.”, nice and small are opinion words and both are mentioned. Proximities of these opinion words to the identified categories reveals the categories to which each relates; here nice corresponds to a customer service category (as identified by the keyword staff), while small corresponds to a room category (as identified by the keyword room).

2. Sentiment sentences might contain both likes and dislikes about the same category. For instance in the following sentence, “Rooms are small and clean.”, the writer is (presumably) not happy with the size of the room, but happy with the room being tidy and neat. Such sentences must also be captured and reported as both negative and positive.

3. For a sentence that contains a contrastive clause (e.g., sentences that start with or include words such as “but”, “however”, etc.) that indicates a sentiment change for features in the clause, the effective opinion in that clause is used to identify the orientation of the categories. However, if there is no category orientation in the clause, then the polarity of the contrastive clause is identified as the opposite polarity of the remainder of the sentence.

The sentiment engine may also be configured (e.g., via the trained model) to handle manifestations of negation: if there is a negation keyword before a sentiment-bearing keyword and its distance to the sentiment-bearing keyword is less than a predetermined threshold, then the polarity of the sentiment sentence may be determined to be the opposite of the polarity of the sentiment-bearing keyword that is associated with the category keyword. For example, in the sentence, “The rooms were not large.”, the opinion-bearing keyword large is associated with the category keyword room and, ordinarily, would be deemed to express a positive sentiment. However, because the word not is determined to modify the sentiment-bearing keyword large, the sentiment engine may determine that the opposite sentiment is, in fact, being expressed.

Sentiment candidates or sentiment sentences identified as discussed above might also be determined to contain wishes, thoughts, beliefs, etc., concerning a product. As such, they may not reflect actual opinions concerning an indentified category. Accordingly, in some embodiments of the present invention the sentiment engine applies a filtering technique, wherein keywords such as “guess”,“believe”,“wish”, and other terms expressing desires rather than true opinions, are treated as sentiment eliminators. Any sentiment candidates or sentiment sentences determined to contain such keywords are eliminated from the sentiment sentences list. A dictionary of such eliminators may be provided to the sentiment engine as part of the trained model or in addition thereto.

After identifying the orientation of a sentiment sentence, the sentiment engine identities how strong the sentiment is. The severity of an opinion can he measured by associating each opinion-bearing keyword with a sentiment score. For example, the sentiment score for the opinion-bearing keyword “fact” may he while the sentiment score for the opinion-bearing keyword “horrible” may be −3 (e.g., on a scale where the sign of the sentiment score is indicative of a positive or negative polarity and the magnitude of the sentiment score indicates the strength or severity thereof). Assigning an overall severity score may require comparison of multiple reviews and an averaging thereof.

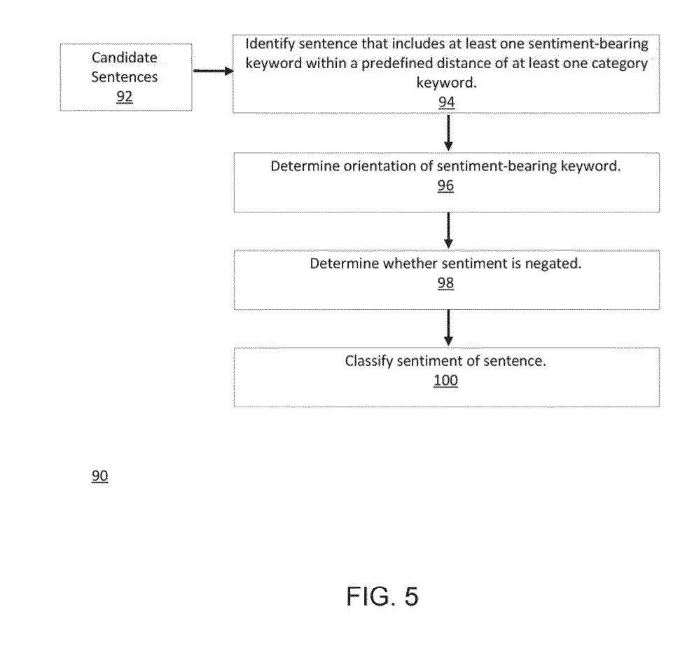

FIG. 5 is a flowchart illustrating the highlights of a method 90 for determining sentiment expressed in a sentence of a document (e.g., a harvested Web page or the like), according to embodiments of the present invention. For candidate sentences 92 (which candidates may be grammatical units larger than, equal to, or smaller than a grammatical sentence) provided to the sentiment engine 28, at step 94, a sentence that includes at least one sentiment-bearing keyword within a predetermined distance of at least one candidate keyword is identified. The sentiment-bearing keyword should be a word (e.g., an adjective) indicating an expression of sentiment. At 96, the orientation or polarity of the sentiment-bearing keyword is determined (e.g., using the trained model provided to the sentiment engine). The polarity may indicate that the sentiment-bearing keyword reflects a positive sentiment, a negative sentiment, or a neutral sentiment. At 98, the sentiment engine determines whether the assessed polarity is negated (e.g., due to the presence of any sentiment negating, words in proximity to the sentiment-bearing keyword). Then, at 100, the sentiment engine classifies the sentiment of the sentence. Not shown, although an optional component of method 90 is an option to discard a candidate sentence if the sentiment engine determines that one or more sentiment eliminators are present in the candidate sentence,

By way of example for the process described with respect to FIG. 5, consider an exemplary document that includes an exemplary sentence: “The room was stinky and the carpets were dirty.” Assume that the words “stinky” and “dirty” are sentiment-bearing keywords expressing a negative sentiment (e.g., a negative polarity), and the words “room” and “carpets” are category (or sub-category) keywords. The sentiment engine identifies this candidate sentence as including the sentiment-bearing keywords “stinky” and “dirty” and identifies that these sentiment-bearing keywords are in sufficient proximity to the category keywords “room” and “carpets”, respectively, hence, the candidate sentence is passed for further processing. In this example, room and carpet may be sub-categories of a broader category of “hotel room”, or may be categories of their own, in either instance,, the sentiment identifies “dirty” and “stinky” as sentiment-bearing keywords expressing a negative sentiment. There are no sentiment negating words, hence, the sentence is classified as one that expresses a negative sentiment concerning a hotel room (and/or a room and carpet). This sentence and its classification may be subsequently stored and statistics reflecting the classification updated.

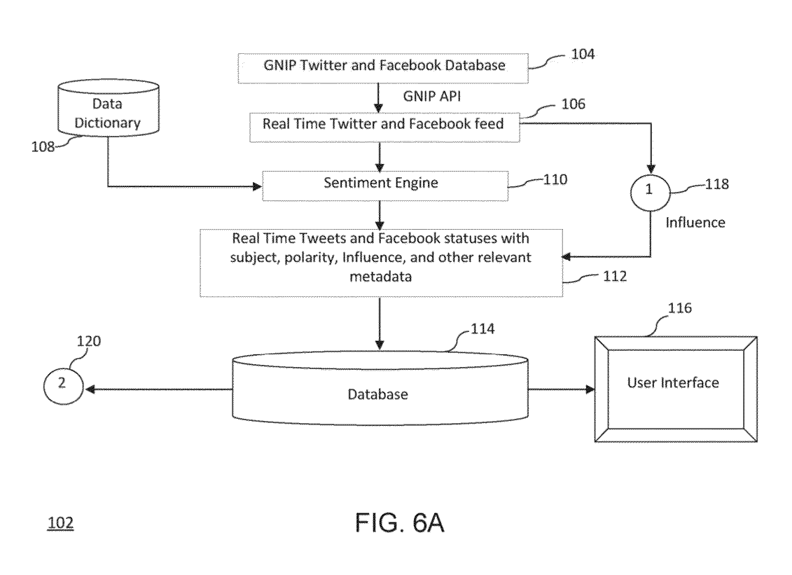

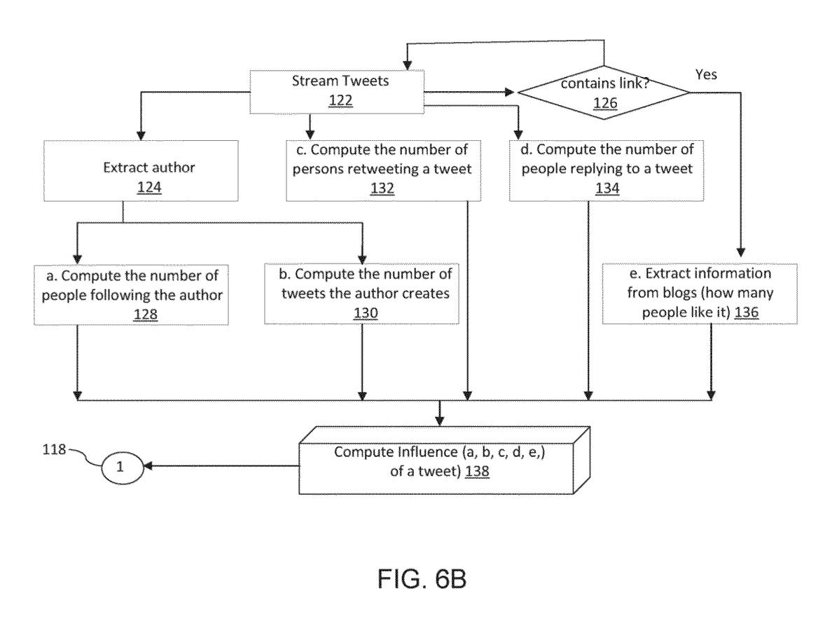

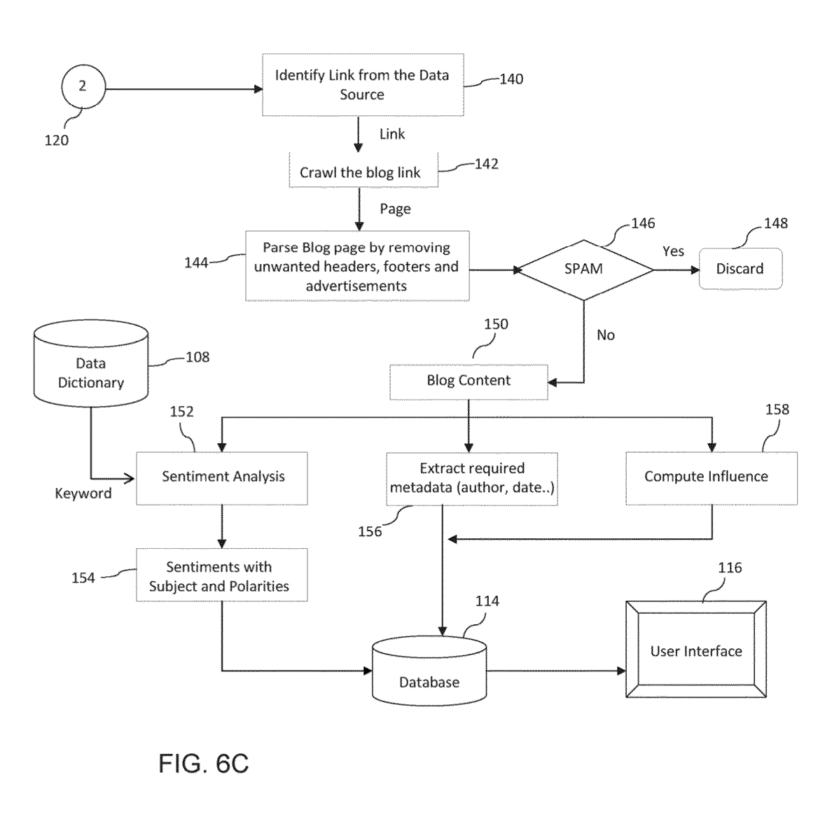

FIGS. 6A-6C, which collectively represent one composite graphical representation, are flow diagrams illustrating one embodiment of the sentiment determination and influence analysis process 102 as applied to Twitter tweets (or feeds). At block 104, each of the host social media sites 14 has its own database, including GNIP database, Twitter database and Facebook database. The GNIP database, for example, is a social media application programming interfaces (API) aggregator which would supply GNIP API, which provides notification of activities (events) occurring, in a variety of services including a user “tweet” (Twitter), a user “dugg” (digg), a user creating a blog post, etc. Twitter tweets, Facebook status updates and other feeds from social media APIs (e.g., GNIP APIs) may also be processed using the sentiment engine 28. Near real time results may be reported using a real time user interface. The process involved in obtaining the relevant feeds and determining the corresponding sentiments is shown in FIGS. 6A-6C. In one embodiment, the process involves three steps:
STEP 1: Fetching real time feeds from GNIP
STEP 2: Processing the GNIP data
STEP 3: Displaying data on Real Time User Interface

STEP 1: At block 106, the sentiment engine 28 is configured to fetch real time feeds from GNIP. GNIP has a streaming API from which can fetch real time tweet feeds and Facebook status feeds by querying the API with keywords. This can replace the crawlers described above, or the crawlers can be instantiated so as to provide keywords from data dictionary 108 to the APIs and retrieve the resulting streams by the sentiment engine 28 at block 110. The feeds are provided in JavaScript Object Notation (JSON) format and the resulting data is queued to be read by processes described in step 2.

STEP 2. Processing the GNIP data. At block 112, the queued data is processed by the sentiment engine 28 (one can use multiple threads across multiple queues) to determine category and polarity for each feed and again queue these results. This queue is then written to a database at block 114. The process may be parallelized to handle high volumes of data.

The sentiment determination and influence analysis process 102 includes supplying information source 118 (circular symbol 1) between the real time Twitter and Facebook feed 106 and the real time tweets and Facebook statuses with subject, polarity, influence, and other relevant metadata 114. The information source 118 can be provided using a variety of methods, including Klout score (see 2.1 below) or compute influence of a tweet (see 2.2 below).

2.1 Klout score: A Klout score may be provided as a parameter by a GNIP API. Klout scores measure the influence of the individual posting the tweet, etc., based on his/her ability to drive action. It relies on the fact that every time content is created, the poster of the content somehow influences others. The Klout score uses data from social networks in order to measure, how many people are so influenced, how those individuals are influenced, the influence of the poster's network.

2.2 Influence computation. The present real time user interface shows the influence of the tweet and the author thereof, thus letting a user sort tweets based on influence. The influence of the tweet is computed with the following five exemplary parameters, which alternatively could be user-defined with more or fewer parameters. Initially, the message analysis module 44 is configured to stream one or more tweets at step 122. At step 124, the message analysis module 44 then is configured to extract a particular author. At step 126, the message analysis module 44 is configured to determine if a tweet includes a link, such as an URL to a website.
At step 128 (influence factor a), the message analysis module 44 is configured to compute the number of people following the author of the subject tweet (follower).
At step 130 (influence factor b), the message analysis module 44 is configured to compute the number of tweets on a given subject that the author of a subject tweet creates (freq).
At step 132 (influence factor c), the message analysis module 44 is configured to compute the number of people re-tweeting a subject tweet (retw).
At step 134 (influence factor d), the message analysis module 44 is configured to compute the number of people replying to the subject tweet (reply).
Optionally, the message analysis module 44 is configured to compute the number of people the author of the subject tweet is following (followee) as another influence factor.
   a) In some blogs, at step 136 (influence factor e), the message analysis module 44 is configured to extract indicator buttons for Facebook, Twitter, Linkedin, delicious™, Dig™, and MySpace™, thus, the message analysis module 44 extracts “likes” counts in Facebook, Linkedin, delicious, Dig, and MySpace (likes).
   b) In addition the sentiment engine 28 is configured to count the number of people who use a subject blog for their tweet information (blog tweet).

In one embodiment, at step 138, an influential score module 46 is configured to compute influence formula that has these seven parameters, which can also be referred to as a Twitter Influence score (TIS). An example is;

TIS=freq×follower×retw×reply×followee×likes×blog tweet.

For calculating influence, the TIS score is compared with a Klout score. The TIS score takes into account the number of followers, number following, listed count and status count. A curve fitting formula may be used to derive a final influence score, for example, taking into account the content of the tweet (keywords, etc.), language of the tweet, whether or not the tweet uses profanity or other unacceptable language, etc. An example of a final influence computation is:

$${\sum }_{i = 1}^{n} {a}_{t} {S}_{feature}$$

where S_{feature} is calculated on the basis of the above-mentioned parameters (some, but not all of which, may be obtained from GNIP data).

Due the fact there are many Twitter authors that tweet about many subjects, the influence scores may be skewed, To correct for such cases, the score is scaled according to the total number of tweets obtained directly from Twitter.com: to obtain a ratio, defined as the number of tweets in our database divided by the total number of tweets on twitter.com/author. For an Internet marketer, this ratio could be very small because the author's business requires this author to tweets about tens or hundreds subjects. This author, even having a high TIS score, should be discarded.

2.3 Spam check: A spam check may be performed on the tweets to avoid potential problems. At step 140, the sentiment engine 28 is configured to identify link from the data source of host social media websites. At step 142, the sentiment engine 28 is configured to crawl the one or more blogs associated with the identified link. At step 144, the sentiment engine 28 is configured to parse blog pages by removing unwanted headers, footers, and advertisement. In one embodiment, the sentiment engine 28, at step 146, is configured to analyze electronic messages, such as Twitter tweets, to find certain patterns as spam. At step 146, if the sentiment engine 28 locates same patterns in some tweets then may discard such electronic messages or tweets considering them as spam. Also some tweeters are market advertisers. Setting thresholds on various filters eliminates at least some of the tweets from them. Such irrelevant tweets are not processed by sentiment engine. If the electronic messages are not considered as spam the sentiment engine 28 continues, at step 150, to obtain blog content.

2.4 Sentiment engine refinement. In one embodiment, a sentiment engine, similar to the sentiment engine 28 but could be a more simplified version, may be specially configured for the sentiment analysis of tweets and public Facebook status updates, both of which are shorter (i.e., limited to 140 characters) and busier than other forms of social media. For illustration purpose, the sentiment engine 28 is used for describing the process. The sentiment engine 152 is configured to process blog content through steps 152 for sentiment analysis, 154 for identifying sentiments with subject and polarities, 156 for extracting metadata including author and date, and 158 for computing the degree of influence.

Moreover, a LAMP architecture may be used for the application. Before applying the proposed approach, the reviews must be split into sentences, which may be units that are equal to, smaller than or larger than a grammatical sentence. Then these units are processed to identify the categories they mention as explained above. After categories are identified, the sentiment bearing keywords are extracted. These are then are expanded to a full opinion-bearing keywords list as described above. The polarity of each sentiment sentence is identified as discussed above.

STEP 3. Displaying data on the real time user interface

At block 116, the real time user interface (UI) queries the database to provide user-selected filters, generate different types of near real time buzz and polarity plots, and enable Boolean search of the database. The UI has a reply feature attached to each tweet wherein the author of the tweet can be replied to directly from the UI by authenticating with Twitter.

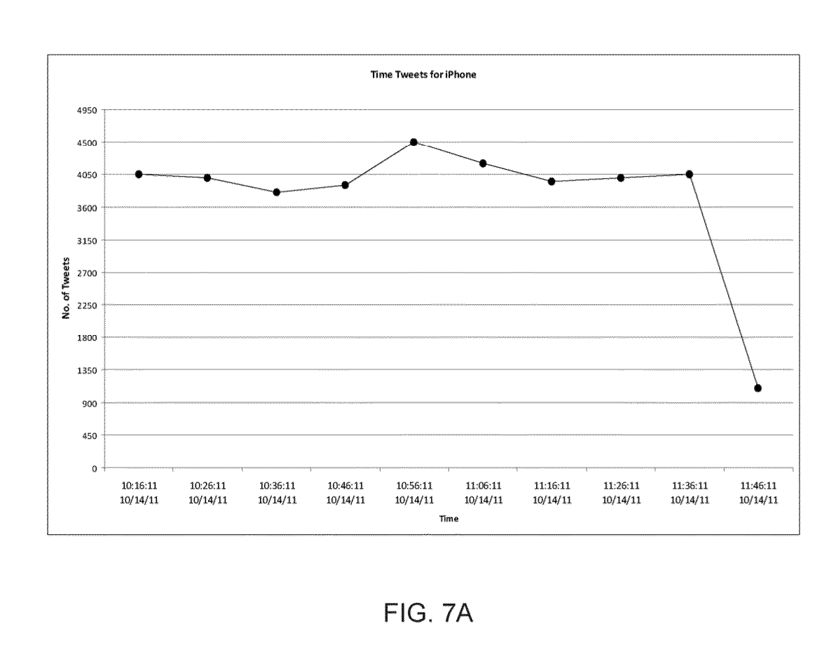

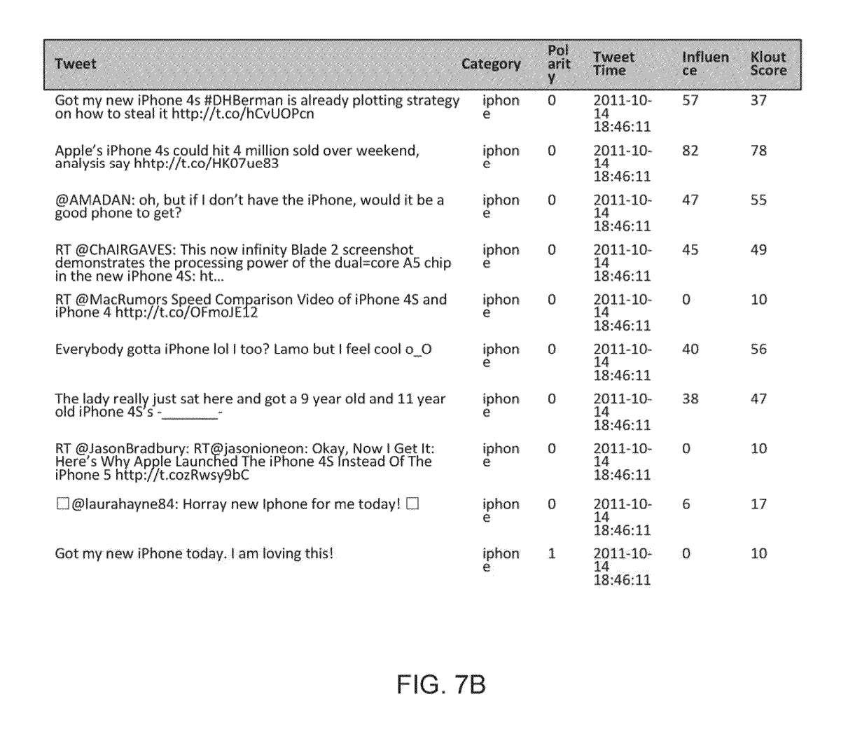

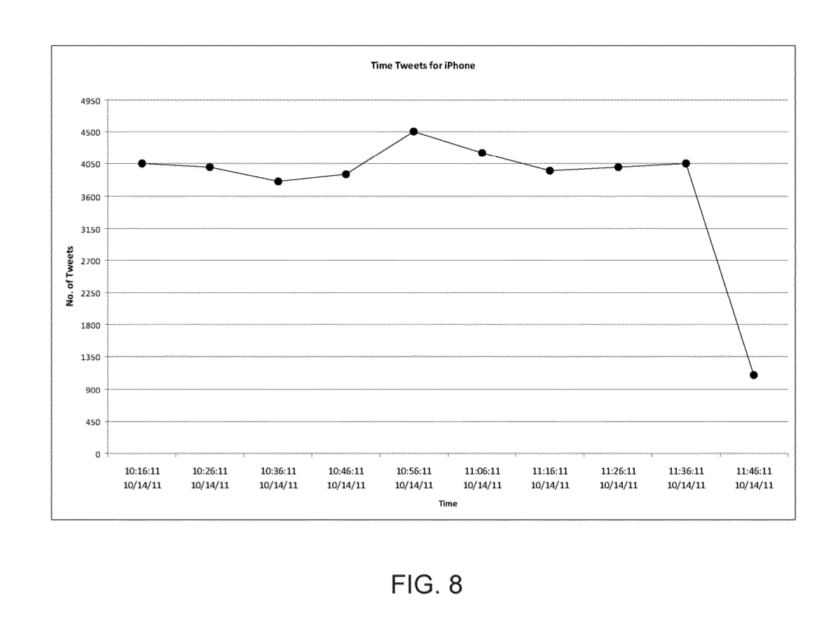

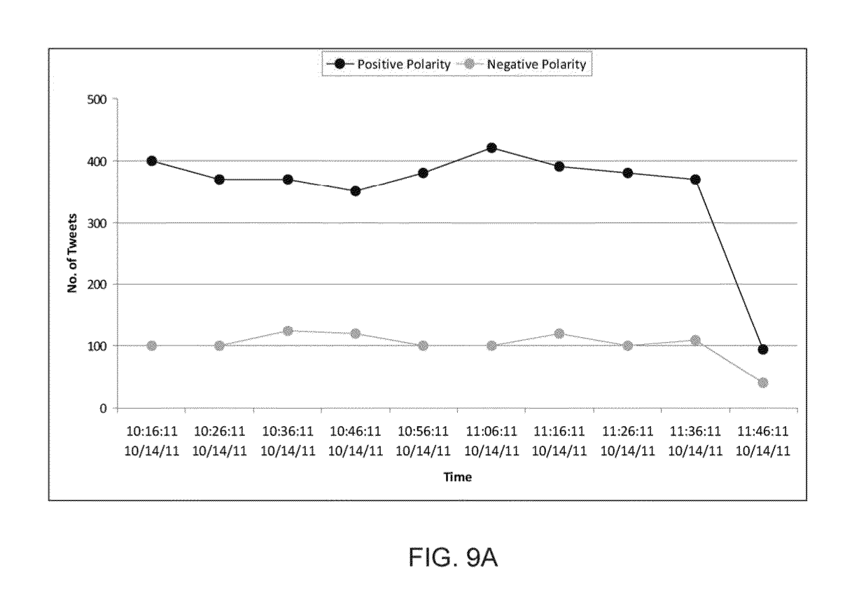

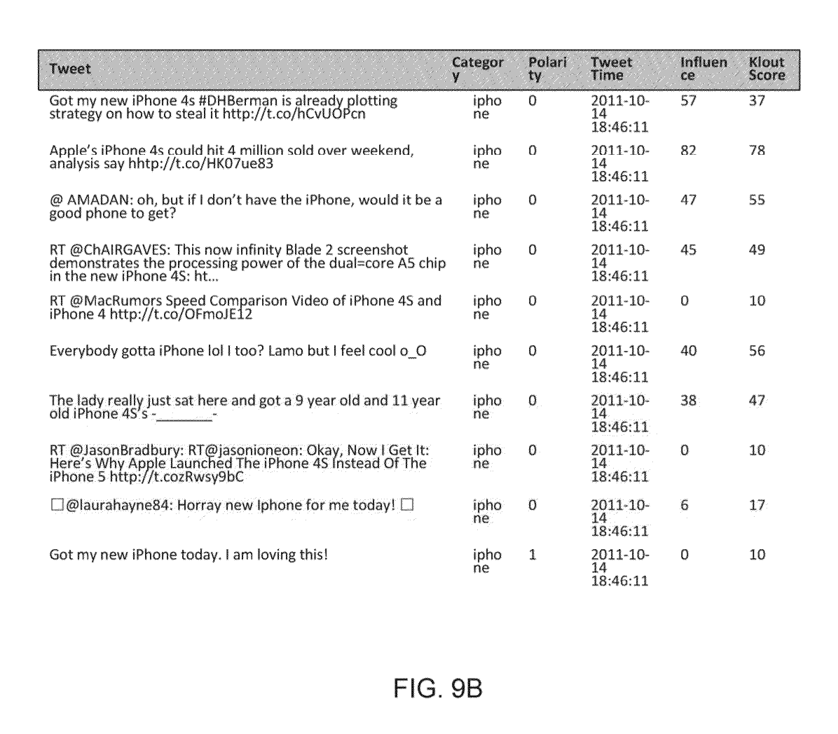

FIGS. 7A-7B show the screen shot of the UI for a smart phone (e.g., an iPhone™) showing a graph with buzz feature. The graph can be switched between buzz and sentiment view. The UI shows the search feature where tweets can be searched on the basis of keywords. The table displays the tweets at that instant of time. The table contains a tweet, its polarity and category. In addition to the above, the screen displays Klout score and influence (computed in accordance with the above-described process). FIG. 8 shows a buzz plot. FIGS. 9A-9B show a screen shot of the UI with the sentiment feature.

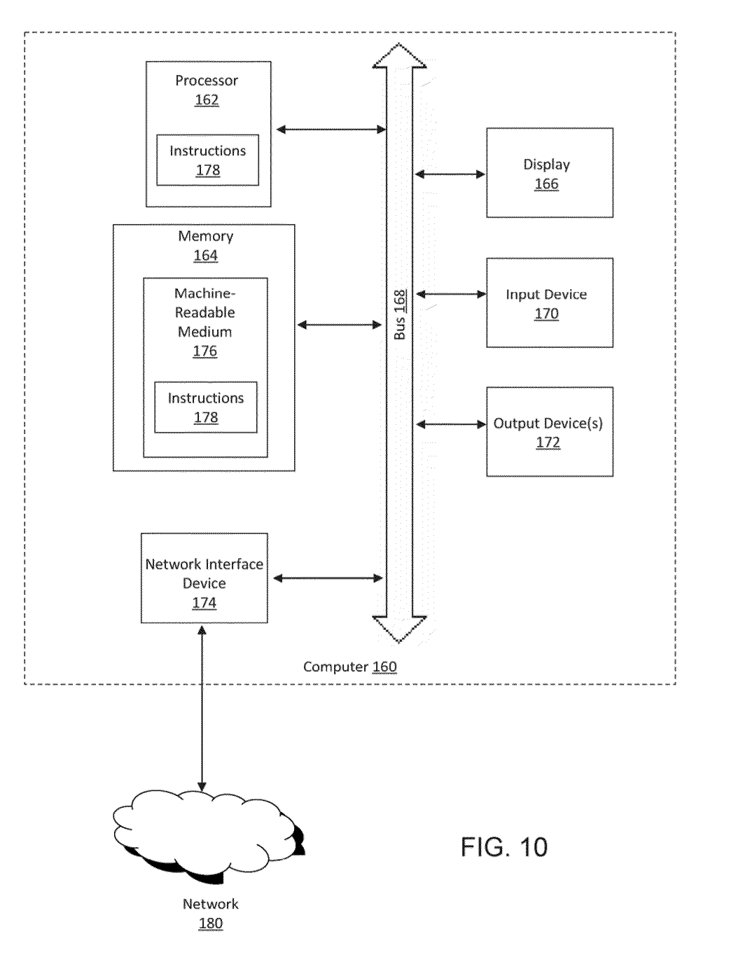

FIG. 10 is a block diagram of a machine in the example form of a computer system 160 within which may be executed a set of instructions for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in a server-client network environment or as a peer machine in a peer-to-peer (pr distributed) network environment.

The machine is capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example of the computer system 160 includes a processor 162 (e.g., a central processing unit (CPU), a graphics processing unit (GPU) or both), and memory 164, which communicate with each other via bus 168. Memory 164 includes volatile memory devices (e.g., DRAM, SRAM, DDR RAM, or other volatile solid state memory devices), non-volatile memory devices (e.g., magnetic disk memory devices, optical disk memory devices, flash memory devices, tape drives, or other non-volatile solid state memory devices), or a combination thereof. Memory 164 may optionally include one or more storage devices remotely located from the computer system 160. The computer system 160 may further include video display unit 166 (e.g., a plasma display, a liquid crystal display (LCD) or a cathode ray tube (CRT)). The computer system 160 also includes input devices 170 (e.g., keyboard, mouse, trackball, touchscreen display, etc.), output devices 172 (e.g., speakers), and a network interface device 174. The aforementioned components of the computer system 160 may be located within a single housing or case (e.g., as depicted by the dashed lines in FIG. 6). Alternatively, a subset of the components may be located outside of the housing. For example, the video display unit 166, the input devices 170, and the output device 172 may exist outside of the housing, but be coupled to the bus 168 via external ports or connectors accessible on the outside of the housing.

Memory 164 includes a machine-readable medium 176 on which is stored one or more sets of data structures and instructions 178 (e.g., software) embodying or utilized by any one or more of the methodologies or functions described herein. The one or more sets of data structures may store data. Note that a machine-readable medium refers to a storage medium that is readable by a machine (e.g., a computer-readable storage medium). The data structures and instructions 178 may also reside, completely or at least partially, within memory 164 and/or within the processor 162 during execution thereof by computer system 160, with memory 164 and processor 162 also constituting machine-readable, tangible media.

The data structures and instructions 178 may further be transmitted or received over a network 180 via network interface device 174 utilizing any one of a number of well-known transfer protocols HyperText Transfer Protocol (HTTP)). Network 180 can generally include any type of wired or wireless communication channel capable of coupling together computing nodes (e.g., the computer system 160) This includes, but is not limited to, a local area network, a wide area network, or a combination of networks, In some embodiments, network 180 includes the Internet

Certain embodiments are described herein as including logic or a number of components, modules, or mechanisms. Modules may constitute either software modules (e.g., code and/or instructions embodied on a machine-readable medium or in a transmission signal) or hardware modules. A hardware module is a tangible unit capable of performing certain operations and may be configured or arranged in a certain manner. In example embodiments, one or more computer systems (e.g., the computer system 160) or one or more hardware modules of a computer system (e.g., a processor 162 or a group of processors) may be configured by software an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor 162 or other programmable processor) that is temporarily configured by software to perform certain operations. It will be appreciated that the decision to implement a hardware module mechanically, in dedicated and permanently, configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor 162 configured using software, the general-purpose processor 162 may be configured as respective different hardware modules at different times. Software may accordingly configure a processor 162, for example, to constitute a particular hardware module at one instance of time and to constitute a different hardware module at a different instance of time.

Modules can provide information to, and receive information from, other modules. For example, the described modules may be regarded as being communicatively coupled. Where multiples of such hardware modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices, and can Operate on a resource (e.g., a collection of information).

The various operations of example methods described herein may be performed, at least partially, by one or more processors 162 that are temporarily configured (e.g., by software, code, and/or instructions stored in a machine-readable medium) or permanently configured to perform the relevant operations. Whether temporarily or permanently configured, such processors 162 may constitute processor-implemented (or computer-implemented) modules that operate to perform one or more operations or functions. The modules referred to herein may in some example embodiments, comprise processor-implemented (or computer-implemented) modules.

Moreover, the methods described herein may be at least partially processor-implemented (or computer-implemented) and/or processor-executable (or computer-executable). For example, at least some of the operations of a method may be performed by one or more processors 162 or processor-implemented (or computer-implemented) modules. Similarly, at least some of the operations of a method may be governed by instructions that are stored in a computer readable storage medium and executed by one or more processors 162 or processor-implemented (or computer-implemented) modules. The performance of certain of the operations may be distributed among the one or more processors 162, not only residing within a single machine, but deployed across a number of machines. In some example embodiments, the processors 1002 may be located in a single location (e.g., within a home environment, an office environment or as a server farm), while in other embodiments the processors 162 may be distributed across a number of locations.

While the embodiment(s) is (are) described with reference to various implementations and exploitations, it will be understood that these embodiments are illustrative and that the scope of the embodiment(s) is not limited to them. in general, the embodiments described herein may be implemented with facilities consistent with any hardware system or hardware systems defined herein. Many variations, modifications, additions, and improvements are possible.

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the embodiment(s). In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the embodiment(s).

As used herein any reference to “one embodiment” or “an embodiment” means that a particular element, feature, structure, or characteristic described in connection with the embodiment is included in at least one embodiment The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following A is true (or present) and B is false (or not present), A is false (or not present) and B is true (or present), and both A and B are true (or present)

The terms “a” or “an,” as used herein, are defined as one or more than one. The term “plurality,” as used herein, is defined as two or more than two. The term “another,” as used herein, is defined as at least a second or more.

The foregoing description, for purpose of explanation, has been described with reference to specific embodiments. However, the illustrative discussions above are not intended to be exhaustive or to limit the embodiments to the precise forms disclosed. Many modifications and variations are possible in view of the above teachings. The embodiments were chosen and described in order to best explain the principles and its practical applications, to thereby enable others skilled in the art to best utilize the embodiments and various embodiments with various modifications as are suited to the particular use contemplated.

What is claimed and desired to be secured by Letters Patent of the United States is:

1. A computer-implemented method for sentiment and influential analysis, comprising:
receiving, by a processor, a plurality electronic messages posted by one or more users on social media web websites;
identifying, by a processor, a polarity of the sentiment-bearing keywords for each electronic message using a phase transition formula;
determining, by a processor, at least one category corresponding to the at least one sentiment-bearing keyword associated with each electronic message; and
determining, by a processor, an influence attribute for each electronic message based on a plurality of influence factors.

2. The method of claim 1, prior to the receiving step, further comprising crawling, by processor, a plurality of social media websites to obtain electronic messages.

3. The method of claim 1, prior to the receiving step, further comprising crawling, by a processor, a plurality of websites to obtain metadata from social media websites.

4. The method of claim 1, after the determining at least one category step, determining at least one sentiment corresponding to the at least one category based on the at least one sentiment-bearing keyword.

5. The method of claim 1, wherein the plurality of influence factors in the influence attribute comprise determining the number of people following an author associated with each message.

6. The method of claim 1, wherein the plurality of influence factors in the influence attribute comprise the number of electronic messages that an author has created

7. The method of claim 1, wherein the plurality of influence factors in the influence attribute comprise the number of resending or forwarding a particular electronic message

8. The method of claim 1, wherein the plurality of influence factors in the influence attribute comprise the number of people replying to a particular electronic message.

9. The method of claim 1, wherein the plurality of influence factors in the influence attribute comprise extracting information from the social media websites the number of people that expressed liking a particular electronic message.

10. The method of claim 1, wherein the plurality of influence factors in the influence attribute comprise determining the number of people an author of a particular electronic message is following.

11. The method of claim 1, wherein the electronic messages comprises message feeds from the social media. websites.

12. The method of claim 1, wherein the extracting step comprises filtering the sentiment-bearing keywords with sentiment eliminators.

13. The method claim 1, wherein the extracting step comprises filtering the sentiment-bearing keywords by associating with a sentiment score.

14. The method of claim 1, wherein extracting step comprises extracting opinion bearing keywords from social media content;
for each keyword,
calculating a frequency, f, of the keyword in the plurality of documents and a number of documents, N, that include the keyword;
using the phase transition formula to calculate the relevancy of the keyword based on the frequency of the keyword in the plurality of documents and the number of documents that include the keyword; and
adding the keyword to the list of keywords when the relevancy of the keyword exceeds a predetermined threshold.

15. The computer-implemented method of claim 4, wherein the phase transition formula is
$$\frac{f}{{N}^{x}} ,$$
wherein x≧1.

16. The method of claim 1, wherein prior to determining step, the method further comprises generating the list of categories by:
determining pairs of keywords in the list of keywords that are related to each other, wherein the pairs of keywords are unique pairs of keywords;
identifying sets of the pairs of the keywords in which each set includes at least one keyword that is common to all of the pairs of keywords in the set; and
until a predetermined termination condition is achieved, iteratively combining the set of the pairs of keywords in which each combined set includes at least one keyword that is common to all of the pairs of keywords in the combined set.

17. The method of claim 1, wherein determining the at least one category corresponding to the at least one keyword of the sentence includes using a neural network to determine the at least one category corresponding to the at least one keyword of the sentence.

18. The method of claim 1, wherein determining the at least one category corresponding to the at least one keyword of the sentence includes:
obtaining a plurality of category spectrums, a respective category spectrum including a frequency of occurrence of keywords in the list of keywords that corresponds to a respective category,
determining a category spectrum for the sentence based on the at least one keyword;
calculating dot products of the category spectrum for the sentence and each category spectrum in the plurality of category spectrums; and
determining the at least one category as a category corresponding to at least one dot product that exceeds a predetermined threshold.

19. The method of claim 18, wherein prior to obtaining the plurality of category spectrums, the method further comprises for each category, determining a category spectrum for the category by:
obtaining a corpus of documents corresponding to the category;
extracting keywords from each document in the corpus of documents;
filtering the keywords using the phase transition formula to produce filtered keywords;
determining the frequency of occurrence of the filtered keywords in the corpus of documents; and
normalizing the frequency of occurrence of the filtered keywords to produce the category spectrum for the category.

20. A system to determine sentiment expressed in a document, comprising:
at least one processor;
memory; and
at least one program stored in the memory, the at least one program comprising instructions to:
receiving, by a processor, a plurality electronic messages posted by one or more users on social media web websites;
identifying, by a processor, a polarity of the sentiment-bearing keywords for each electronic message using a phase transition formula;
determining, by a processor, at least one category corresponding to the at least one sentiment-bearing keyword associated with each electronic message; and
determining, by a processor, an influence attribute for each electronic message based on a plurality of influence factors.
